(19) United States
(12) Patent Application Publication
(10) Pub. No.: US 2016/0053408 A1
(43) Pub. Date: Feb. 25, 2016

(54) HIGH STRENGTH CONSTANT COMPRESSION ELASTIC FIBERS AND FABRICS THEREOF

(71) Applicant: Lubrizol Advanced Materials, Inc., Cleveland, OH (US)

(72) Inventors: Ravi R. Vedula, North Ridgeville, OH (US); James E. Bryson Jr., Cuyahoga Falls, OH (US); Mouh-Wahng Lee, Solon, OH (US); Christopher A. Sprague, Cuyahoga Falls, OH (US); Daniel M. Fischer, Brentwood, TN (US)

(21) Appl. No.: 14/747,548

(22) Filed: Aug. 18, 2015

Related U.S. Application Data
(63) Continuation of application No. 13/160,635, filed on Jun. 15, 2011, now abandoned.
(60) Provisional application No. 61/354,823, filed on Jun. 15, 2010.

(51) Int. Cl. D01F 6/70; C08G 18/76; C08G 18/32; D01F 6/62; D01D 5/08

(52) U.S. Cl. CPC D01F 6/70; D01F 6/62; D01D 5/08; C08G 18/3221; C08G 18/7685; D10B 2331/10; D10B 2331/04; D10B 2501/00

(57) ABSTRACT

The present invention relates to high strength fabrics made thereof from thin gauge constant compression elastic fibers. Elastic fibers are disclosed which have a relatively flat modulus curve, for example between 100% and 200% elongation. Garments made with the constant compression elastic fibers have a more comfortable feel to the wearer. The garments are also resistant to puncture due to the high strength fabric made with the elastic fibers.

### CROSS REFERENCE TO RELATED APPLICATION

This application claims benefit pursuant to 35 U.S.C. 119(e) of Provisional Application Ser. No. 61/354,823 filed on Jun. 15, 2010.

### FIELD OF THE INVENTION

The present invention relates to high strength fabrics made thereof from thin gauge constant compression elastic fibers. Garments made with the constant compression elastic fibers have a more comfortable feel to the wearer. The garments are also resistant to puncture due to the high strength fabric made with the elastic fibers.

### BACKGROUND OF THE INVENTION

In recent years, the demand for greater functionality in garments has increased demand for compression fabrics. These fabrics, while providing compression, also become uncomfortable due to increased heat buildup and often become too tight or too heavy or too bulky. It would be desirable for a garment to provide an optimal degree of compression specific to the wearer without loss of comfort. It is also desired for a thinner gauge fabric which allows for lowering packing volumes, reduction of a feeling of “bulk” and in the case of undergarments, a lack of external visibility through the outer garment.

Synthetic elastic fibers (SEF) are normally made from polymers having soft and hard segments to give elasticity. Polymers having hard and soft segments are typically poly(ether-amide), such as Pebax® or copolyesters, such as Hytrel® or thermoplastic polyurethane, such as Estane®. However, very high elongation SEF typically utilize hard and soft segmented polymers such as dry spun polyurethane (Lycra®) or melt spun thermoplastic polyurethane (Estane®). While these SEF vary, from low to very high, in elongation of break, all can be commonly described as having an exponentially increasing modulus (stress) with an increase in elongation (strain). That is, they do not have relatively constant and/or flat compression profiles.

Melt spun TPU fibers offer some advantages over dry spun polyurethane fibers in that no solvent is used in the melt spun process, whereas in the dry spinning process, the polymer is dissolved in solvent and spun. The solvent is then partially evaporated out of the fibers. All of the solvent is very difficult to completely remove from the dry spun fibers. To facilitate removing the solvent from dry spun fibers, they are typically made into a small size and bunched together to create a multi-filament (ribbon-like) fiber. This results in a larger physical size for a given denier as compared to a melt spun fiber. These physical characteristics result in more bulk in the fabric and the nature of the multi-filament bundle contributes to a loss of comfort.

It would be desirable to have a TPU elastic fiber which has a relatively constant compression between zero and 250% elongation, or at least a more relatively constant compression compared to more conventional fibers. Also, it would be desirable for these constant compression fabrics, made from such fiber, to be thin gauge and be of a high puncture resistance. Garments made from such fabrics would offer more comfort and confidence to the wearer.

### BRIEF DESCRIPTION OF THE DRAWINGS

FIG. 1 is a photo micrograph of a 70 denier multi-filament of a commercial dry spun polyurethane fiber.

FIG. 2 is a photo micrograph of a 70 denier of a melt spun constant compression thermoplastic polyurethane fiber of the present invention.

FIG. 3 is a graph showing the X axis as denier vs. the Y axis of fiber width squared (square microns). The fiber of this invention is compared to a commercial dry spun fiber.

### SUMMARY OF THE INVENTION

It is an object of the present invention to provide a melt-spun fiber having an ultimate elongation of at least 400% and having a relatively flat modulus in the load and unload cycle between 100% and 200% elongation.

The invention further provides such a fiber with a modulus, on the 5^{th} pull cycle that does not increase by more than 400% on the load cycle between 100% and 200% elongation. Also provided is any such fiber as a monofilament fiber that is 30 to 300 microns in diameter.

The invention further provides a Jersey knit fabric from any such fiber having a burst puncture strength, as measured by ASTM D751, such that the load/thick at failure is at least 710 lbf/in (124 N/mm), and in some of these embodiments the Jersey knit fabric has is made from fiber having an average denier of no more than 80, 75, or even about 70, wherein these limits may apply to Jersey knit fabrics made from 100% of the described fibers (i.e., no co-fibers are present).

The invention provides any of the fibers described herein where: (i) the denier of the fiber is from 40 to 90; (ii) the modulus of the fiber, on the 5^{th} pull cycle, increases between 80 and 130% on the load cycle between 100% and 200% elongation; (iii) a Jersey knit fabric prepared from said fibers has a burst puncture strength, as measured by ASTM D751, such that the load/thick at failure for the fabric is between 710 and 1600 lbf/in (124 and 280 N/mm); (iv) where the fiber is monofilament and has a diameter of 80 to 100 microns; or (v) any combination thereof.

The invention provides any of the fiber described herein where: (i) the denier of the fiber is from 90 to 160; (ii) the modulus of the fiber, on the 5^{th} pull cycle, increases between 50 and 120% on the load cycle between 100% and 200% elongation; (iii) the fiber is monofilament and has a diameter of 100 to 150 microns; or (iv) any combination thereof.

The invention provides any of the fiber described herein where: (i) the denier of the fiber is from 300 to 400; (ii) the modulus of the fiber, on the 5^{th} pull cycle, increases between 50 and 150% on the load cycle between 100% and 200% elongation; (iii) the fiber is monofilament and has a diameter of 180 to 220 microns; or (iv) any combination thereof.

The invention further provides a Jersey knit fabric prepared from any of the fibers described herein. In some embodiments, the fabric has a burst puncture strength, as measured by ASTM D751, such that (i) the energy to failure is at least 25 lbf-in. (2.8 N-m), (ii) the load at failure is at least 6 pounds (2.7 kg), or (iii) combinations thereof. In some of these embodiments the Jersey knit fabric has is made from fiber having an average denier of no more than 80, 75, or even about 70, wherein these limits may apply to Jersey knit fabrics made from 100% of the described fibers (i.e., no co-fibers are present).

In some embodiments, the fiber is a thermoplastic polyurethane fiber. In some of these embodiments, the fiber is a polyester thermoplastic polyurethane, optionally reacted with a rheology modifying agent (RMA), for example, it may be crosslinked with a polyether crosslinking agent.

The invention further provides a fabric comprising at least two different fibers wherein at least one of said fibers is any of the fibers described herein.

The invention further provides a process for producing a melt-spun elastic fiber having an ultimate elongation of at least 400% and having a relatively flat modulus in the load and unload cycle between 100% and 200% elongation, said process comprising: (a) melt spinning a thermoplastic elastomer polymer through a spinneret; and (b) winding the elastic fiber into bobbins at a winding speed which is no greater than 50% of the polymer melt velocity exiting the spinneret.

### DETAILED DESCRIPTION OF THE INVENTION

Various preferred features and embodiments will be described below by way of non-limiting illustration.

### The Fibers and Fabrics

The fibers of this invention have a relatively constant modulus at room temperature in the load and unload cycle between 100% and 200% elongation. In some embodiments, the fiber of this invention has an elongation at break of at least 400%, or about 450 to 500%. The superlative fiber of this invention has a nearly perfect constant modulus at body temperature. This room temperature/body temperature constant compression is evidenced by the example provided herein.

The standard test procedure employed to obtain the values described here is one developed by DuPont for elastic yarns. The test subjects fibers to a series of 5 cycles. In each cycle, the fiber is stretched to 300% elongation, and relaxed using a constant extension rate (between the original gauge length and 300% elongation). The % set is measured after the 5^{th} cycle. Then, the fiber specimen is taken through a 6^{th} cycle and stretched to breaking. The instrument records the load at each extension, the highest load before breaking, and the breaking load in units of grams-force per denier as well as the breaking elongation and elongation at the maximum load. The test is normally conducted at room temperature (23° C.±2° C.; and 50%±5% humidity).

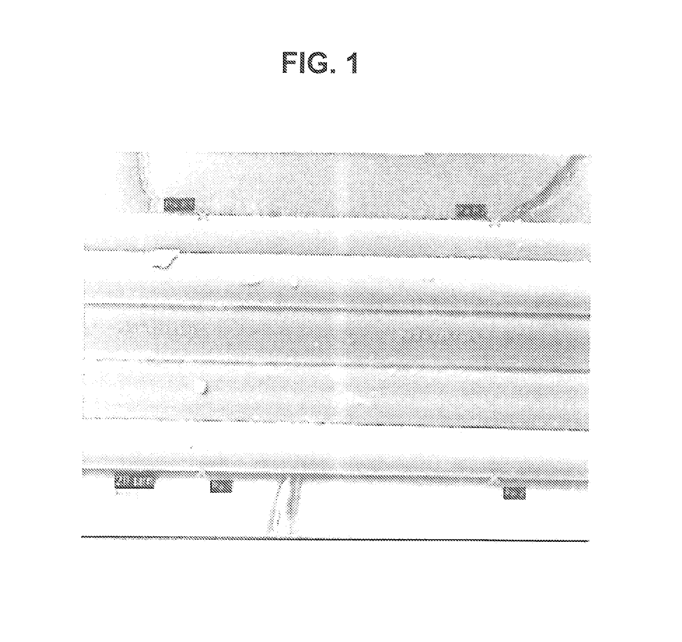

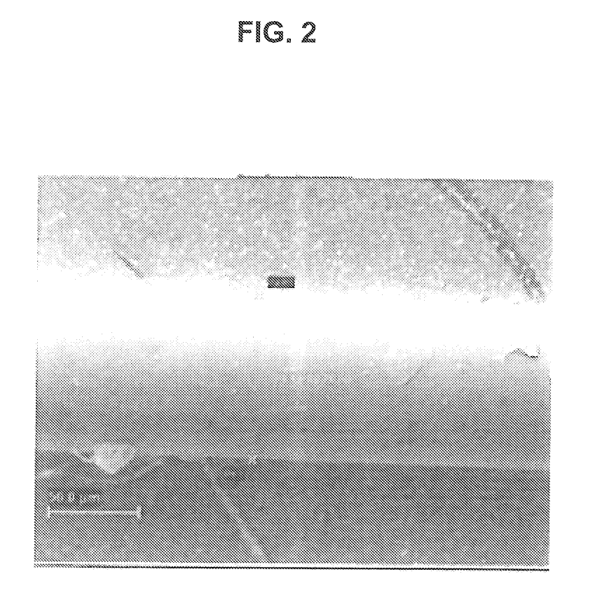

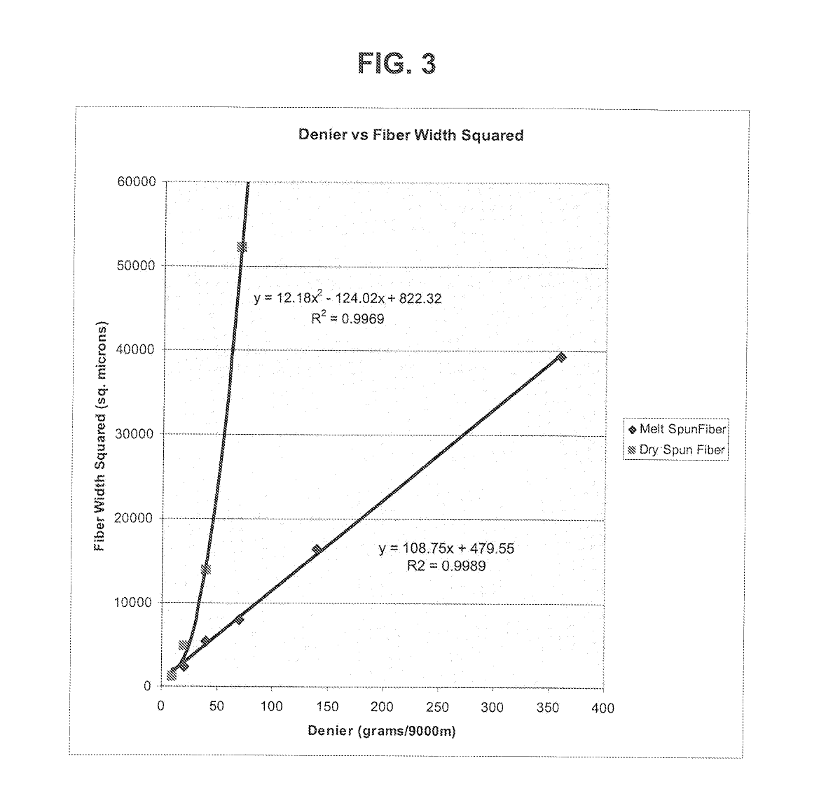

In some embodiments, the fiber of the invention has a round cross-section. Referring to FIG. 2, it can be seen that a 70 denier fiber according to the invention is substantially round in cross sectional shape. FIG. 1 shows a typical and industry standard 70 denier ribbon-like high elongation SEF which has a different and larger cross sectional width. FIG. 3 shows a typical and industry standard 70 denier ribbon-like, high elongation SEF compared with the thin gauge, constant compression, high strength fiber of this invention at room temperature. The variable denier/cross-sectional area (d/square microns) is used to make a comparison. The fiber of this invention has a small constant slope, whereas the dry spun fiber has not only a large but an exponentially increasing slope. The result is that fabric made with the fiber of the invention can not only deliver comparable strength (as evidence by the measurements) in an overall thinner gauged fabric, as demonstrated by FIG. 3, but also that a single fabric within a garment (or other application) can conform to different dimensions without giving up comfort or without developing a sense of being too tight or taught as a result of the fiber's relatively constant compression properties.

Another feature of fabrics made from the fibers of this invention is that such fabrics have superior burst strength as compared to fabrics of similar stretch and gauge. And the exceptional feel and hand of this inventive fabric gives the user the sense of a fine textile as opposed to a rubbery-ness which is common for a similar fabric based on the typical and industry standard ribbon-like, high elongation SEF.

These features are illustrated by the Ball Burst Puncture Strength Test (ASTM D751) using a 1 inch diameter ball. In some embodiments, the fabrics of this invention show about a 50% to 75% improvement in burst strength as compared to a fabric based on the typical and industry standard ribbon-like, high elongation SEF.

The fabric of this invention also has more efficient drying and cooling capacity. This is believed to be due to the improved porosity of the fabric of this invention. The resultant improved venting of generated heat and moisture will give the user a sense of comfort and confidence.

Fabrics that utilize the fibers of this invention can be made by knitting or weaving or by non-woven processes such as melt blown or spun bond. In some embodiments, the fabric of this invention is made using one or more different (conventional) fibers in combination with the fibers of the invention. Hard fibers, such as nylon and/or polyester may be used, but others such as rayon, silk, wool, modified acrylic and others can also be utilized to make the fabric of this invention.

In some embodiments, the fabric of this invention is one knitted using alternating fibers, such as 140 denier TPU fiber according to the present invention in combination with 70 denier nylon used in alternating strands (referred to as a 1-1 fabric) or 140 denier TPU fiber according to the present invention in combination with 70 denier nylon followed used in a 2:1 alternating strand ratio (referred to as 1-2 fabric).

Various garments can be made with the fabric of this invention. In some embodiments, the fabric is used in making undergarments or tight fitting garments, for which the fabrics of this invention are well-suited due to the comfort provided by the fiber. Undergarments, such as bras and T-shirts as well as sport garments used for activities such as running, skiing, cycling, or other sports, can benefit from the properties of these fibers. Garments worn next to the body benefit from the flat modulus of these fibers, because the modulus is even lower once the fibers reach body temperature. A garment that feels tight will become more comfortable in about 30 seconds to 5 minutes after the fibers reach body temperature. It will be understood by those skilled in the art that any garment can be made from the fabric and fibers of this invention. An exemplary embodiment would be a bra shoulder strap made from woven fabric and the wings of the bra made from knitted fabric, with both the woven and the knitted fabric containing the melt spun TPU fibers of this invention. The bra strap would not require an adjustable clasp because the fabric is elastic.

In other embodiments, the fibers described herein are used to make one or more of any number of garments and articles including but not limited to: sports apparel, such as shorts, including biking, hiking, running, compression, training, golf, baseball, basketball, cheerleading, dance, soccer and/or hockey shorts; shirts, including any of the specific types listed for shorts above; tights including training tights and compression tights; swimwear including competitive and resort swimwear; bodysuits including wrestling, running and swimming body suits; and footwear. Additional embodiments include workwear such as shirts and uniforms. Additional embodiments include intimates including bras, panties, men's underwear, camisoles, body shapers, nightgowns, panty hose, men's undershirts, tights, socks and corsetry. Additional embodiments include medical garments and articles including: hosiery such as compression hosiery, diabetic socks, static socks, and dynamic socks; therapeutic burn treatment bandages and films; wound care dressings; medical garments. Additional applications include military applications that mirror one or more of the specific articles described above. Additional embodiments include bedding articles including sheets, blankets, comforters, mattress pads, mattress tops, and pillow cases.

Still another feature of the present invention is that the fibers described herein have greater strength, for example, they produce a fabric with a higher burst strength, compared to more conventional fibers of the same gauge, and/or provide the same or even higher strength compared to conventional fibers of a larger gauge. That is, the fibers of the present invention provide greater strength at the same or even lower gauge compared to conventional fibers. One benefit of this feature is that the fibers of the present invention may be used in a wider range of knitting machines without operational problems that is the fibers of the present invention may be used in knitting machines set-up for fibers of the same gauge or even fibers of a larger gauge. In contrast, conventional fibers cannot be used in knitting machines set-up for a larger gauge fiber as the conventional fiber would not be strong enough to allow for proper operation of the machine. This feature is a considerable benefit of the present invention. In some embodiments, the fibers of the present invention are used in the operation of a knitting machine set-up for a fiber with a gauge 5%, 10% or even 20% larger than the gauge of the fiber of the present invention being used. For example, a 40 gauge fiber, or even a 40 denier fiber, of the present invention may be successfully used in a 54 gauge knitting machine. In other words, the fabrics of the present invention may be knit in finer gauge knitting machines, resulting in finer and smoother fabrics while still providing high compression.

As noted above, the fibers of the present invention are melt-spun and have an ultimate elongation of at least 400% and also have a relatively flat modulus in the load and unload cycle between 100% and 200% elongation. By relatively flat, it is meant that the modulus does not vary as much as it does for other conventional fibers such as nylon and/or polyester and/or any other thermoplastic elastic fibers in the marketplace (including spandex fibers).

In some embodiments, the modulus of the fiber (measured by the method described above), on the 5^{th} pull cycle, has a modulus that does not increase by more than 400% on the load cycle between 100% and 200% elongation. In some embodiments, the fiber has a denier from 4, 10, 20, 30, 40 70 or even 140 up to 8000, 2000, 1500, 1200, 600, 400, 360, or even 140. Such fibers may on the 1^{st} pull cycle, have a modulus that increases, on the load cycle between 100% and 200% elongation, from 50% or 60% up to 150% or 95%. Such fibers may on the 5^{th} pull cycle, have a modulus that increases, on the load cycle between 100% and 200% elongation, from 50% or 75% up to 150% or 110%.

In some embodiments, the fibers of the present invention may be described as fibers that, when made to a denier of about 70, on the 1^{st} pull cycle, have a modulus that increases, on the load cycle between 100% and 200% elongation, from 70%, 80% or even 85% up to 120%, 100% or even 95%. In some embodiments, the fibers of the present invention may be described as fibers that, when made to a denier of about 70, on the 5^{th} pull cycle, have a modulus that increases, on the load cycle between 100% and 200% elongation, from 80%, 90% or even 95% up to 130%, 110% or even 105%.

In some embodiments, the fibers of the present invention may be described as fibers that, when made to a denier of about 140, on the 1^{st} pull cycle, have a modulus that increases, on the load cycle between 100% and 200% elongation, from 50%, 55% or even 63% up to 100%, 80% or even 75%. In some embodiments, the fibers of the present invention may be described as fibers that, when made to a denier of about 140, on the 5^{th} pull cycle, have a modulus that increases, on the load cycle between 100% and 200% elongation, from 50%, 95% or even 100% up to 150%, 120%, 115% or even 109%.

In some embodiments, the fibers of the present invention may be described as fibers that, when made to a denier of about 360, on the 1^{st} pull cycle, have a modulus that increases, on the load cycle between 100% and 200% elongation, from 40%, 60% or even 65% up to 100%, 80%, 85% or even 70%. In some embodiments, the fibers of the present invention may be described as fibers, that when made to a denier of about 360, on the 5^{th} pull cycle, have a modulus that increases, on the load cycle between 100% and 200% elongation, from 50%, 60% or even 70% up to 120%, 100%, 80% or even 78%.

It is noted that in the embodiments above, the fiber is not limited to the specific denier size for which the results are specified. Rather, the fibers are described by noting what the modulus would be if the fiber were made to a specific denier and tested. In contrast, the embodiments below deal with fibers of specified denier.

In some embodiments, the fibers of the present invention have denier of from 4, 10, 35 or even 60 up to 130, 100, 80 or even 70. In any of these embodiments, the fibers may have an average denier of about 70. In such embodiments, the fibers may have a modulus: on the 1^{st} pull, on the load cycle between 100% and 200% elongation, from 70%, 80% or even 85% up to 120%, 100% or even 95%; and on the 5^{th} pull, on the load cycle between 100% and 200% elongation, from 80%, 90% or even 95% up to 130%, 110% or even 105%.

In some embodiments, the fibers of the present invention have denier of from 80, 90, 100, 120 or even 140 up to 300, 250, 200, or even 160. In some embodiments, the fibers have an average denier of about 140. In any of these embodiments, the fibers may have a modulus: on the 1^{st} pull, on the load cycle between 100% and 200% elongation, from 50%, 55% or even 63% up to 100%, 80% or even 75%; and on the 5^{th} pull, on the load cycle between 100% and 200% elongation, from 50%, 95% or even 100% up to 150%, 120%, 115% or even 109%.

In some embodiments, the fibers of the present invention have denier of from 150, 200, or even 300 up to 1500, 500, 450 or even 200. In some embodiments, the fibers have an average denier of about 360. In any of these embodiments, the fibers may have a modulus: on the 1^{st} pull, on the load cycle between 100% and 200% elongation, from 40%, 60% or even 65% up to 100%, 80%, 85% or even 75%; and on the 5^{th} pull, on the load cycle between 100% and 200% elongation, from 50%, 60% or even 70% up to 120%, 100%, 80% or even 78%.

In some embodiments, the present invention may be described by looking to the properties of a Jersey knit fabric made from the fibers described here. In some embodiments, the fiber of the present invention, when knitted into a Jersey fabric, provides a fabric with a burst puncture strength, as measured by ASTM D751, such that the load/thick at failure is at least 710, 800, 900, 1000, 1100, 1200, 1250 lbf/in, or in other embodiments at least 124, 140, 158, 175, 193, 210 or even 219 N/mm. In any of these embodiments, the burst strength may have a maximum value of no more than 1600 or 1500 lbf/in, or in other embodiments of no more than 280 or 263 N/mm.

In some embodiments, the invention is a fiber, according to any of the embodiments described above, where the fiber, if made to 70 denier and then made into a Jersey knit fabric, would provide a Jersey knit fabric with a burst puncture strength (load/thick at failure) of at least 710, 800, 900, 1000, 1200, or even 1250, up to 1400 lbf/in, and in other embodiments at least 124, 140, 158, 175, 210 or even 219, up to 245 N/mm. In any of these embodiments, the fibers may also provide a Jersey knit fabric with a burst puncture strength such that the energy to fail is at least 25, 30, 35, 40, or 40.5 up to 200, 100 or 75 lbf-in, and in other embodiments at least 2.8, 3.4, 4.0, 4.5, or 4.6 up to 22.6, 11.3, or 8.5 N-m. In any of these embodiments, still the fibers may also provide a Jersey knit fabric with a burst puncture strength such that the load at failure is at least 6, 7, 8, or 9 up to 50, 40 or 20 lb, and in other embodiments at least 2.7, 3.2, 3.6 or even 4.1, up to 22.7, 18.1 or 9.1 kg.

In some embodiments, the invention is a fiber, according to any of the embodiments described above, where the fiber, if made to 140 denier and then made into a Jersey knit fabric, would provide a Jersey knit fabric with a burst puncture strength (load/thick at failure) of at least 1200, 1300, 1500, 1700, or even 1750, up to 1900 lbf/in, and in other embodiments at least 210, 228, 263, 298 or even 306, up to 333 N/mm. In any of these embodiments, the fibers may also provide a Jersey knit fabric with a burst puncture strength such that the energy to fail is at least 60, 70, 75, 80, or even 83.5 up to 800, 200, or 150 lbf-in, and in other embodiments at least 6.8, 7.9, 8.5, 9.0, or 9.4 up to 90.3, 22.6, or 16.9 N-m. In any of these embodiments, still the fibers may also provide a Jersey knit fabric with a burst puncture strength such that the load at failure is at least 10, 15, 17, or even 17.5 up to 100, 75, 50, or 25 lb, and in other embodiments at least 4.5, 6.8, 7.7 or even 7.9, up to 45.4, 34.0, 22.7 or 11.3 kg.

In some embodiments, the invention is a fiber, according to any of the embodiments described above, where the fiber, if made to 40 denier and then made into a Jersey knit fabric, would provide a Jersey knit fabric with a burst puncture strength (load/thick at failure) of at least 500, 750, 1000, 1400 or even 1450, up to 1600 or 1500 lbf/in, and in other embodiments at least 88, 131, 175, 245 or even 254, up to 280 or 263 N/mm. In any of these embodiments, the fibers may also provide a Jersey knit fabric with a burst puncture strength such that the energy to fail is at least 10, 15, 20 or even 20.5 up to 100, 75, or 50 lbf-in, and in other embodiments at least 1.1, 1.7, or 2.3 up to 11.3, 8.5, or 5.6 N-m. In any of these embodiments, still the fibers may also provide a Jersey knit fabric with a burst puncture strength such that the load at failure is at least 3, 4, 4.5 or even 5 up to 40, 20, or 10 lb, and in other embodiments at least 1.4, 1.8, 2.0, or even 2.3, up to 18.1, 9.1, or 4.5 kg.

It is noted that in the embodiments above, the fiber is not limited to the specific denier size for which the results are specified. Rather, the fibers are described by noting what the burst strength of the Jersey knit fabric made from the fiber would be if the fiber were made to a specific denier and tested. In contrast, the embodiments below deal with fibers of specified denier.

In some embodiments, the fibers of the present invention have denier of from 4, 10, 35, or even 60 up to 130, 100, or even 80 denier, and in some embodiments an average denier of about 70. In any of these embodiments, the fibers may provide a Jersey knit fabric with a burst puncture strength of at least 710, 800, 1000, 1200, or even 1250, up to 1400 lbf/in, and in other embodiments at least 124, 140, 175, 210 or even 219, up to 245 N/mm. In any of these embodiments, the fibers may also provide a Jersey knit fabric with a burst puncture strength such that the energy to fail is at least 25, 30, 35, 40, or 40.5 up to 200, 100 or 75 lbf-in, and in other embodiments at least 2.8, 3.4, 4.0, 4.5, or 4.6 up to 22.6, 11.3, or 8.5 N-m. In any of these embodiments, still the fibers may also provide a Jersey knit fabric with a burst puncture strength such that the load at failure is at least 6, 7, 8, or 9 up to 50, 40 or 20 lb, and in other embodiments at least 2.7, 3.2, 3.6 or even 4.1, up to 22.7, 18.1 or 9.1 kg.

In some embodiments, the fibers of the present invention have denier of from 80, 90, 100, 120 or even 140 up to 300, 250, 200, or even 160, or in some embodiments an average denier of about 140. In any of these embodiments, the fibers may provide a Jersey knit fabric with a burst puncture strength (load/thick at failure) of at least 1200, 1300, 1500, 1700, or even 1750, up to 1900 lbf/in, and in other embodiments at least 210, 228, 263, 298 or even 306, up to 333 N/mm. In any of these embodiments, the fibers may also provide a Jersey knit fabric with a burst puncture strength such that the energy to fail is at least 60, 70, 75, 80, or even 83.5 up to 800, 200, or 150 lbf-in, and in other embodiments at least 6.8, 7.9, 8.5, 9.0, or 9.4 up to 90.3, 22.6, or 16.9 N-m. In any of these embodiments, still the fibers may also provide a Jersey knit fabric with a burst puncture strength such that the load at failure is at least 10, 15, 17, or even 17.5 up to 100, 75, 50, or 25 lb, and in other embodiments at least 4.5, 6.8, 7.7 or even 7.9, up to 45.4, 34.0, 22.7 or 11.3 kg.

In some embodiments, the fibers of the present invention have denier of from 20, 30, 35, or even 40 up to 100, 75, 60, or even 50, or in some embodiments an average denier of about 40. In any of these embodiments, the fibers may provide a Jersey knit fabric with a burst puncture strength (load/thick at failure) of at least 500, 750, 1000, 1400 or even 1450, up to 1600 or 1500 lbf/in, and in other embodiments at least 88, 131, 175, 245 or even 254, up to 280 or 263 N/mm. In any of these embodiments, the fibers may also provide a Jersey knit fabric with a burst puncture strength such that the energy to fail is at least 10, 15, 20 or even 20.5 up to 100, 75, or 50 lbf-in, and in other embodiments at least 1.1, 1.7, or 2.3 up to 11.3, 8.5, or 5.6 N-m. In any of these embodiments, still the fibers may also provide a Jersey knit fabric with a burst puncture strength such that the load at failure is at least 3, 4, 4.5 or even 5 up to 40, 20, or 10 lb, and in other embodiments at least 1.4, 1.8, 2.0, or even 2.3, up to 18.1, 9.1, or 4.5 kg.

The fibers of the present invention may be monofilament fibers. In some embodiments, the fibers have a diameter of 10, 30, 40 or even 45 up to 500, 400, 300 or even 200 microns.

In some embodiments, the fibers of the present invention: when made to a denier of 20 will have a diameter of 20 or 30 to 55 or 50 microns; when made to a denier of 40 will have a diameter of 40 or 60 to 85 or 80 microns; when made to a denier of 70 will have a diameter of 75 or 80 to 130 or 100 microns; when made to a denier of 140 will have a diameter of 80 or 100 to 300 or 150 microns; when made to a denier of 360 will have a diameter of 175 or 190 to 225 or 210 microns; or any combination thereof.

It is noted that in the embodiments above, the fiber is not limited to the specific denier size or diameter provided. Rather, the fibers are described by noting what the diameter the fiber would have if the fiber were made to a specific denier. In contrast, the embodiments below deal with fibers of specified denier.

In some embodiments, the fibers of the present invention have a denier of 10 to 30, or an average of about 20, and in such embodiments the fibers have a diameter of from 10, 20 or even 30 to 65, 60, 55 or even 50 microns, and in some embodiments an average diameter of 48 microns.

In some embodiments, the fibers of the present invention have a denier of 30 to 40, or an average of about 30, and in such embodiments the fibers have a diameter of from 20, 30, 40 or even 60 to 115, 100, 85 or even 80 microns, and in some embodiments an average diameter of 73 microns.

In some embodiments, the fibers of the present invention have denier of from 4, 10, 35 or even 60 up to 130, 100, or 80, or an average of about 70. In such embodiments, the fibers have a diameter of from 50, 60, 70, 75, or even 80 to 220, 200, 150, 130, or even 100 microns, and in some embodiments an average diameter of 89 microns.

In some embodiments, the fibers of the present invention have denier of from 80, 90, 100, 120 or 140 up to 300, 250, 200, or 160. In some embodiments, the fibers have an average denier of about 140. In such embodiments, the fibers have a diameter of from 50, 70, 80, or even 100 to 300, 250, 200, or even 150 microns, and in some embodiments an average diameter of 128 microns.

In some embodiments, the fibers of the present invention have denier of from 150, 200, or even 300 up to 1500, 500, 450 or even 200. In some embodiments, the fibers have an average denier of about 360. In such embodiments, the fibers have a diameter of from 100, 150, 175, or even 190 to 400, 250, 225, or even 210 microns, and in some embodiments an average diameter of 198 microns.

In some embodiments, the diameter of the fiber of the present invention is described by a formula where the diameter of the fiber, in microns, is approximately equal to 11.7 times the denier of the fiber raised to the power of 0.48 (Diameter=11.7×Denier^{0.48}). In some embodiments, the diameter of the fiber is within a 20, 10 or even 5 micron range centered on the result of the described equation.

In some embodiments, the fiber of the present invention has a denier of 40 to 90; a modulus, on the 5^{th} pull cycle, that increases between 80 and 130% on the load cycle between 100% and 200% elongation; a burst puncture strength, when made into a Jersey knit fabric, as measured by ASTM D751, such that the load/thick at failure for the fabric is between 710 and 1600 lbf/in (124 and 280 N/mm); and is monofilament with a diameter of 80 to 100 microns.

In some embodiments, the fiber of the present invention has a denier of 90 to 160; a modulus, on the 5^{th} pull cycle, that increases between 50 and 120% on the load cycle between 100% and 200% elongation; and is monofilament with a diameter of 100 to 150 microns.

In some embodiments, the fiber of the present invention has a denier of 300 to 400; a modulus, on the 5^{th} pull cycle, that increases between 50 and 150% on the load cycle between 100% and 200% elongation; and is monofilament with a diameter of 180 to 220 microns.

### The Polymer

The fibers of the invention are made from a polymer. In some embodiments, the fiber is made from a thermoplastic polyurethane polymer. In some of these embodiments, the polyurethane is a polyester thermoplastic polyurethane. In some embodiments, the polyurethane is reacted with a rheology modifying agent, for example it may be cross-linked with a polyether cross-linking agent. The fibers themselves may have a weight average molecular weight (Mw) of at least 500,000 (500k). The fibers may have a Mw of at least 500k, 600k, or even 650k and may be so high as to be beyond any current means of measurement, or in some embodiments as high as 1.2 million. In addition, the polymer from which the fibers are made may have an Mw of 500k to 1500k. The polymer may have a Mw of more than 500k, 600k or even 650k and may have an Mw of no more than 1500k or even 1000k.

The fiber of this invention may be made from a thermoplastic elastomer. In some embodiments, the thermoplastic elastomer is a thermoplastic polyurethane (TPU). The invention will generally be described herein using a TPU, but it should be understood that this is only one embodiment and other thermoplastic elastomers can be used by those skilled in the art.

The TPU polymer type used in this invention can be any conventional TPU polymer that is known to the art and in the literature as long as the TPU polymer has adequate molecular weight, as defined below. Suitable TPU polymers may be prepared by reacting a polyisocyanate with an intermediate such as a hydroxyl terminated polyester, a hydroxyl terminated polyether, a hydroxyl terminated polycarbonate or mixtures thereof, with one or more chain extenders, all of which are well known to those skilled in the art.

The hydroxyl terminated polyester intermediate is generally a linear polyester having a Mn of from about 500 to about 10,000, or from about 700 to about 5,000, or even from about 700 to about 4,000, an acid number generally less than 1.3 or less than 0.8. The molecular weight is determined by assay of the terminal functional groups and is related to the number average molecular weight. The polymers are produced by (1) an esterification reaction of one or more glycols with one or more dicarboxylic acids or anhydrides or (2) by transesterification reaction, i.e., the reaction of one or more glycols with esters of dicarboxylic acids. Mole ratios generally in excess of more than one mole of glycol to acid are preferred so as to obtain linear chains having a preponderance of terminal hydroxyl groups. Suitable polyester intermediates also include various lactones such as polycaprolactone typically made from ε-caprolactone and a bifunctional initiator such as diethylene glycol. The dicarboxylic acids of the desired polyester can be aliphatic, cycloaliphatic, aromatic, or combinations thereof. Suitable dicarboxylic acids which may be used alone or in mixtures generally have a total of from 4 to 15 carbon atoms and include: succinic, glutaric, adipic, pimelic, suberic, azelaic, sebacic, dodecanedioic, isophthalic, terephthalic, cyclohexane dicarboxylic, and the like. Anhydrides of the above dicarboxylic acids such as phthalic anhydride, tetrahydrophthalic anhydride, or the like, can also be used. In some embodiments, the acid is adipic acid. The glycols which are reacted to form a desirable polyester intermediate can be aliphatic, aromatic, or combinations thereof, and have a total of from 2 to 12 carbon atoms, and include ethylene glycol, 1,2-propanediol, 1,3-propanediol, 1,3-butanediol, 1,4-butanediol, 1,5-pentanediol, 1,6-hexanediol, 2,2-dimethyl-1,3-propanediol, 1,4-cyclohexanedimethanol, decamethylene glycol, dodecamethylene glycol, and the like. In some embodiments, the glycol includes 1,4-butanediol.

Hydroxyl terminated polyether intermediates are polyether polyols derived from a diol or polyol having a total of from 2 to 15 carbon atoms, preferably an alkyl diol or glycol which is reacted with an ether comprising an alkylene oxide having from 2 to 6 carbon atoms, typically ethylene oxide or propylene oxide or mixtures thereof. For example, hydroxyl functional polyether can be produced by first reacting propylene glycol with propylene oxide followed by subsequent reaction with ethylene oxide. Primary hydroxyl groups resulting from ethylene oxide are more reactive than secondary hydroxyl groups and thus are preferred. Useful commercial polyether polyols include poly(ethylene glycol) comprising ethylene oxide reacted with ethylene glycol, polypropylene glycol) comprising propylene oxide reacted with propylene glycol, poly(tetramethyl glycol) comprising water reacted with tetrahydrofuran (PTMEG). In some embodiments, the polyether intermediate is polytetramethylene ether glycol (PTMEG). Polyether polyols further include polyamine adducts of an alkylene oxide and can include, for example, ethylenediamine adduct comprising the reaction product of ethylenediamine and propylene oxide, diethylenetriamine adduct comprising the reaction product of diethylenetriamine with propylene oxide, and similar polyamine type polyether polyols. Copolyethers can also be utilized in the current invention. Typical copolyethers include the reaction product of THF and ethylene oxide or THF and propylene oxide. These are available from BASF as Poly THF B, a block copolymer, and poly THF R, a random copolymer. The various polyether intermediates generally have a number average molecular weight (Mn) as determined by assay of the terminal functional groups which is an average molecular weight greater than about 700, such as from about 700 to about 10,000, or from about 1000 to about 5000, or even from about 1000 to about 2500. A particular desirable polyether intermediate is a blend of two or more different molecular weight polyethers, such as a blend of 2000 Mₙ and 1000 Mₙ PTMEG.

One embodiment of this invention uses a polyester intermediate made from the reaction of adipic acid with a 50/50 blend of 1,4-butanediol and 1,6-hexanediol.

The polycarbonate-based polyurethane resin of this invention is prepared by reacting a diisocyanate with a blend of a hydroxyl terminated polycarbonate and a chain extender. The hydroxyl terminated polycarbonate can be prepared by reacting a glycol with a carbonate. U.S. Pat. No. 4,131,731 is hereby incorporated by reference for its disclosure of hydroxyl terminated polycarbonates and their preparation. Such polycarbonates are linear and have terminal hydroxyl groups with essential exclusion of other terminal groups. The essential reactants are glycols and carbonates. Suitable glycols are selected from cycloaliphatic and aliphatic diols containing 4 to 40, or from 4 to 12 carbon atoms, and from polyoxyalkylene glycols containing 2 to 20 alkoxy groups per molecular with each alkoxy group containing 2 to 4 carbon atoms. Diols suitable for use in the present invention include aliphatic diols containing 4 to 12 carbon atoms such as butanediol-1,4, pentanediol-1,4, neopentyl glycol, hexanediol-1,6,2,2,4-trimethylhexanediol-1,6, decanediol-1,10, hydrogenated dilinoleylglycol, hydrogenated dioleylglycol; and cycloaliphatic diols such as cyclohexanediol-1,3, dimethylolcyclohexane-1,4, cyclohexanediol-1,4, dimethylolcyclohexane-1,3, 1,4-endomethylene-2-hydroxy-5-hydroxymethylcyclohexane, and polyalkylene glycols. The diols used in the reaction may be a single diol or a mixture of diols depending on the properties desired in the finished product.

Polycarbonate intermediates which are hydroxyl terminated are generally those known to the art and in the literature. Suitable carbonates are selected from alkylene carbonates composed of a 5 to 7 membered ring having the following general formula:

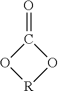

where R is a saturated divalent radical containing 2 to 6 linear carbon atoms. Suitable carbonates for use herein include ethylene carbonate, trimethylene carbonate, tetramethylene carbonate, 1,2-propylene carbonate, 1,2-butylene carbonate, 2,3-butylene carbonate, 1,2-ethylene carbonate, 1,3-pentylene carbonate, 1,4-pentylene carbonate, 2,3-pentylene carbonate, and 2,4-pentylene carbonate.

Also, suitable herein are dialkylcarbonates, cycloaliphatic carbonates, and diarylcarbonates. The dialkylcarbonates can contain 2 to 5 carbon atoms in each alkyl group and specific examples thereof are diethylcarbonate and dipropylcarbonate. Cycloaliphatic carbonates, especially dicycloaliphatic carbonates, can contain 4 to 7 carbon atoms in each cyclic structure, and there can be one or two of such structures. When one group is cycloaliphatic, the other can be either alkyl or aryl. On the other hand, if one group is aryl, the other can be alkyl or cycloaliphatic. Examples of suitable diarylcarbonates, which can contain 6 to 20 carbon atoms in each aryl group, are diphenylcarbonate, ditolylcarbonate, and dinaphthylcarbonate.

The reaction is carried out by reacting a glycol with a carbonate, for example, an alkylene carbonate, in the molar range of 10:1 to 1:10, or from 3:1 to 1:3 at a temperature of 100° C. to 300° C. and at a pressure in the range of 0.1 to 300 mm of mercury in the presence or absence of an ester interchange catalyst, while removing low boiling glycols by distillation.

More specifically, the hydroxyl terminated polycarbonates are prepared in two stages. In the first stage, a glycol is reacted with an alkylene carbonate to form a low molecular weight hydroxyl terminated polycarbonate. The lower boiling point glycol is removed by distillation at 100° C. to 300° C., or at 150° C. to 250° C., under a reduced pressure of 10 to 30 mm Hg, or 50 to 200 mm Hg. A fractionating column is used to separate the by-product glycol from the reaction mixture. The by-product glycol is taken off the top of the column and the unreacted alkylene carbonate and glycol reactant are returned to the reaction vessel as reflux. A current of inert gas or an inert solvent can be used to facilitate removal of by-product glycol as it is formed. When amount of by-product glycol obtained indicates that degree of polymerization of the hydroxyl terminated polycarbonate is in the range of 2 to 10, the pressure is gradually reduced to 0.1 to 10 mm Hg and the unreacted glycol and alkylene carbonate are removed. This marks the beginning of the second stage of reaction during which the low molecular weight hydroxyl terminated polycarbonate is condensed by distilling off glycol as it is formed at 100° C. to 300° C., or even 150° C. to 250° C. and at a pressure of 0.1 to 10 mm Hg until the desired molecular weight of the hydroxyl terminated polycarbonate is attained. Molecular weight (Mn) of the hydroxyl terminated polycarbonates can vary from about 500 to about 10,000, but may also be in the range of 500 to 2500.

The second necessary ingredient to make the TPU polymer of this invention is a polyisocyanate. The polyisocyanates of the present invention generally have the formula R(NCO)ₙ where n is generally from 2 to 4, or even 2 inasmuch as the composition is a thermoplastic. Thus, polyisocyanates having a functionality of 3 or 4 are utilized in very small amounts, for example, less than 5% and desirably less than 2% by weight based upon the total weight of all polyisocyanates, inasmuch as they cause crosslinking R can be aromatic, cycloaliphatic, and aliphatic, or combinations thereof generally having a total of from 2 to about 20 carbon atoms. Examples of suitable aromatic diisocyanates include diphenyl methane-4,4′-diisocyanate (MDI), H₁₂ MDI, m-xylylene diisocyanate (XDI), m-tetramethyl xylylene diisocyanate (TMXDI), phenylene-1,4-diisocyanate (PPDI), 1,5-naphthalene diisocyanate (NDI), and diphenylmethane-3,3′-dimethoxy-4,4′-diisocyanate (TODI). Examples of suitable aliphatic diisocyanates include isophorone diisocyanate (IPDI), 1,4-cyclohexyl diisocyanate (CHDI), hexamethylene diisocyanate (HDI), 1,6-diisocyanato-2,2,4,4-tetramethyl hexane (TMDI), 1,10-decane diisocyanate, and trans-dicyclohexylmethane diisocyanate (HMDI). In some embodiments, the diisocyanate is MDI containing less than about 3% by weight of ortho-para (2,4) isomer.

The third necessary ingredient to make the TPU polymer of this invention is the chain extender. Suitable chain extenders are lower aliphatic or short chain glycols having from about 2 to about 10 carbon atoms and include for instance ethylene glycol, diethylene glycol, propylene glycol, dipropylene glycol, tripropylene glycol, triethylene glycol, cis-trans-isomers of cyclohexyl dimethylol, neopentyl glycol, 1,4-butanediol, 1,6-hexandiol, 1,3-butanediol, and 1,5-pentanediol. Aromatic glycols can also be used as the chain extender and are often the choice for high heat applications. Benzene glycol (HQEE) and xylylene glycols are suitable chain extenders for use in making the TPU of this invention. Xylylene glycol is a mixture of 1,4-di(hydroxymethyl)benzene and 1,2-di(hydroxymethyl)benzene. Benzene glycol is one suitable aromatic chain extender and specifically includes hydroquinone, i.e., bis(beta-hydroxyethyl) ether also known as 1,4-di(2-hydroxyethoxy)benzene; resorcinol, i.e., bis(beta-hydroxyethyl) ether also known as 1,3-di(2-hydroxyethyl)benzene; catechol, i.e., bis(beta-hydroxyethyl) ether also known as 1,2-di(2-hydroxyethoxy)benzene; and combinations thereof. In some embodiments, the chain extender is 1,4-butanediol.

The above three necessary ingredients (hydroxyl terminated intermediate, polyisocyanate, and chain extender) may be reacted in the presence of a catalyst. Generally, any conventional catalyst can be utilized to react the diisocyanate with the hydroxyl terminated intermediate or the chain extender and the same is well known to the art and to the literature. Examples of suitable catalysts include the various alkyl ethers or alkyl thiol ethers of bismuth or tin wherein the alkyl portion has from 1 to about 20 carbon atoms with specific examples including bismuth octoate, bismuth laurate, and the like. Suitable catalysts include the various tin catalysts such as stannous octoate, dibutyltin dioctoate, dibutyltin dilaurate, and the like. The amount of such catalyst is generally small such as from about 20 to about 200 parts per million based upon the total weight of the polyurethane forming monomers.

The TPU polymers of this invention can be made by any of the conventional polymerization methods well known in the art and literature.

Thermoplastic polyurethanes of the present invention may be made via a “one shot” process wherein all the components are added together simultaneously or substantially simultaneously to a heated extruder and reacted to form the polyurethane. The equivalent ratio of the isocyanate groups present in the diisocyanate to the total equivalents of the hydroxyl groups in the hydroxyl terminated intermediate and the diol chain extender is generally from about 0.95 to about 1.10, or from about 0.97 to about 1.03, or even from about 0.97 to about 1.00. The Shore A hardness of the TPU formed should be from 65A to 95A, or from about 75A to about 85A, to achieve the most desirable properties of the finished article. Reaction temperatures utilizing urethane catalyst are generally from about 175° C. to about 245° C. or from about 180° C. to about 220° C. The weight average molecular weight (Mw) of the thermoplastic polyurethane may be from about 100,000 to about 800,000 or from about 150,000 to about 400,000 or even from about 150,000 to about 350,000 as measured by GPC relative to polystyrene standards. In any of these embodiments, the weight average molecular weight (Mw) of the thermoplastic polyurethane polymer is at least 400,000 or even at least 500,000.

The thermoplastic polyurethanes can also be prepared utilizing a pre-polymer process. In the pre-polymer route, the hydroxyl terminated intermediate is reacted with generally an equivalent excess of one or more polyisocyanates to form a pre-polymer solution having free or unreacted polyisocyanate therein. Reaction is generally carried out at temperatures of from about 80° C. to about 220° C. or from about 150° C. to about 200° C. in the presence of a suitable urethane catalyst. Subsequently, a selective type of chain extender as noted above is added in an equivalent amount generally equal to the isocyanate end groups as well as to any free or unreacted diisocyanate compounds. The overall equivalent ratio of the total diisocyanate to the total equivalents of both the hydroxyl terminated intermediate and the chain extender is thus from about 0.95 to about 1.10, or from about 0.98 to about 1.05 or even from about 0.99 to about 1.03. The equivalent ratio of the hydroxyl terminated intermediate to the chain extender is adjusted to give 65A to 95A, or 75A to 85A Shore hardness. The chain extension reaction temperature is generally from about 180° C. to about 250° C. or from about 200° C. to about 240° C. Typically, the pre-polymer route can be carried out in any conventional device with an extruder being preferred. Thus, the hydroxyl terminated intermediate is reacted with an equivalent excess of a diisocyanate in a first portion of the extruder to form a pre-polymer solution and subsequently the chain extender is added at a downstream portion and reacted with the pre-polymer solution. Any conventional extruder can be utilized, with extruders equipped with barrier screws having a length to diameter ratio of at least 20 or at least 25.

The polymer composition used to make the fibers of the present invention may also contain one or more additional additives. Useful additives can be utilized in suitable amounts and include opacifying pigments, colorants, mineral fillers, stabilizers, lubricants, UV absorbers, processing aids, and other additives as desired. Useful opacifying pigments include titanium dioxide, zinc oxide, and titanate yellow, while useful tinting pigments include carbon black, yellow oxides, brown oxides, raw and burnt sienna or umber, chromium oxide green, cadmium pigments, chromium pigments, and other mixed metal oxide and organic pigments. Useful fillers include diatomaceous earth (superfloss) clay, silica, talc, mica, wallostonite, barium sulfate, and calcium carbonate. If desired, useful stabilizers such as antioxidants can be used and include phenolic antioxidants, while useful photostabilizers include organic phosphates, and organotin thiolates (mercaptides). Useful lubricants include metal stearates, paraffin oils and amide waxes. Useful UV absorbers include 2-(2′-hydroxyphenol)benzotriazoles and 2-hydroxybenzophenones.

Plasticizer additives can also be utilized advantageously to reduce hardness without affecting properties.

During the melt spinning process, the TPU polymer described above may be reacted with a rheology modifying agent (RMA), for example the polymer may be lightly cross-linked with a cross-linking agent. Such agents are typically a pre-polymer of a hydroxyl terminated intermediate that is a polyether, polyester, polycarbonate, polycaprolactone, or mixture thereof reacted with a polyisocyanate. In some embodiments, the agent is a polyester, a polyether, or a combination thereof. In some embodiments, a polyether agent is used with a polyester TPU. The crosslinking agent pre-polymer, will have an isocyanate functionality of greater than about 1.0, or from about 1.0 to about 3.0, or even from about 1.8 to about 2.2. In some embodiments, both ends of hydroxyl terminated intermediate is capped with an isocyanate, thus having an isocyanate functionality of 2.0.

The polyisocyanate used to make the RMA agents are the same as described above for making the TPU polymer. In some embodiments, the polyisocyanate is diisocyanate, such as MDI.

The RMA agent prepolymers have a Mw of from about 1,000 to about 10,000, or from about 1,200 to about 4,000 or even from about 1,500 to about 2,800. Cross-linking agents with above about 1500 Mw give better set properties.

The weight percent of RMA agent used with the TPU polymer is from 2.0% to 20%, 8.0% to 15%, or 10% to 13%. The percentage of RMA agent used is weight percent based upon the total weight of TPU polymer and RMA agent.

### The Process

The spinning process to make fibers of this invention involves feeding a preformed polymer compound, such as a TPU, to an extruder to melt the TPU. A rheology modifying agent (RMA), for example the cross-linking agent, may be added continuously downstream near the point where the TPU melt exits the extruder or after the TPU melt exits the extruder. The RMA can be added to the extruder before the melt exits the extruder or after the melt exits the extruder. If added after the melt exits the extruder, the RMA should be mixed with the TPU melt using static or dynamic mixers to assure proper mixing. After exiting the extruder, the melt flows into a manifold. The manifold divides the melt stream into one or more smaller streams, where each stream is fed to a plurality of spinnerets. The spinneret will have small holes through which the melt is forced and the melt exits the spinneret in the form of fiber, in some embodiments the fiber remains a monofilament fiber. The size of the holes in the spinneret will depend on the desired size of the fiber.

The polymer melt may be passed through a spin pack assembly and exit the spin pack assembly as a fiber. In some embodiments, the spin pack assembly used is one which gives plug flow of the polymer through the assembly. In some embodiments, the spin pack assembly is the one described in PCT patent application WO 2007/076380, which is incorporated in its entirety herein.

Once the fiber exits the spinneret, it may be cooled before winding onto bobbins. In some embodiments, the fiber is passed over a first godet, finish oil is applied, and the fiber proceeds to a second godet. An important aspect of the process is the relative speed at which the fiber is wound into bobbins. By relative speed, we mean the speed of the melt (melt velocity) exiting the spinneret in relationship to the winding speed of the bobbin. For a typical TPU melt spinning process, the fiber is wound at a speed of 4-6 times the speed of the melt velocity. This draws or stretches the fiber. For the unique fibers of this invention, this extensive drawing is undesirable. The fibers must be wound at a speed at least equal to the melt velocity to operate the process. For the fibers of this invention, the fiber may be wound onto bobbins at a speed no greater than 50% faster than the melt velocity, in other embodiments at a speed no greater than 20%, 10%, or even 5% faster than the melt velocity. It is thought that a winding speed that is the same as the melt velocity would be ideal, but it is necessary to have a slightly higher winding speed to operate the process efficiently. For example, a fiber exiting the spinneret at a speed of 300 meters per minute, or even at a speed of between 300 and 315 meters per minute. Similar examples are readily apparent.

As noted above, the fibers of this invention can be made in a variety of denier. Denier is a term in the art designating the fiber size. Denier is the weight in grams of 9000 meters of fiber length.

When fibers are made by the process of this invention, anti-tack additives such as finish oils, an example of which are silicone oils, may be added to the surface of the fibers after or during cooling and/or just prior to being wound into bobbins.

One important aspect of the melt spinning process is the mixing of the polymer melt with the crosslinking agent. Proper uniform mixing is important to achieve uniform fiber properties and to achieve long run times without experiencing fiber breakage. The mixing of the melt and crosslinking agent should be a method which achieves plug-flow, i.e., first in first out. The proper mixing can be achieved with a dynamic mixer or a static mixer. Static mixers are more difficult to clean; therefore, a dynamic mixer is preferred. A dynamic mixer which has a feed screw and mixing pins is the preferred mixer. U.S. Pat. No. 6,709,147, which is incorporated herein by reference, describes such a mixer and has mixing pins which can rotate. The mixing pins can also be in a fixed position, such as attached to the barrel of the mixer and extending toward the centerline of the feed screw. The mixing feed screw can be attached by threads to the end of the extruder screw and the housing of the mixer can be bolted to the extruder machine. The feed screw of the dynamic mixer should be a design which moves the polymer melt in a progressive manner with very little back mixing to achieve plug-flow of the melt. The L/D of the mixing screw should be from over 3 to less than 30, or from about 7 to about 20, or even from about 10 to about 12.

The temperature in the mixing zone where the TPU polymer melt is mixed with the crosslinking agent may be from about 200° C. to about 240° C., or from about 210° C. to about 225° C. These temperatures are generally necessary to get the reaction while not degrading the polymer.

The spinning temperature (the temperature of the polymer melt in the spinneret) should be higher than the melting point of the polymer, or from about 10° C. to about 20° C. above the melting point of the polymer. The higher the spinning temperature one can use, the better the spinning. However, if the spinning temperature is too high, the polymer can degrade. In some embodiments, the desired spinning temperature is from 10° C. to 20° C. above the melting point of the TPU polymer. If the spinning temperature is too low, polymer can solidify in the spinneret and cause fiber breakage.

The invention will be better understood by reference to the following non-limiting examples.

### EXAMPLES

The TPU polymer used in the Examples was made by reacting a polyester hydroxyl terminated intermediate (polyol) with 1,4-butanediol chain extender and MDI. The polyester polyol was made by reacting adipic acid with a 50/50 mixture of 1,4-butanediol and 1,6-hexanediol. The polyol had a Mn of 2500. The TPU was made by the one-shot process. The crosslinking agent added to the TPU during the spinning process was a polyether pre-polymer made by reacting 1000 Mn PTMEG with MDI to create a polyether end capped with isocyanate. The crosslinking agent was used at a level of 10 wt. % of the combined weight of TPU plus crosslinking agent. Fiber were melt spun to make 40, 70, 140 and 360 denier fibers used in the Examples.

### Example 1

This Example is presented to show the relative flat modulus curve of the fiber (70 denier) of this invention as compared to an existing prior art melt spun TPU fiber (40 denier) and a commercial dry spun fiber (70 denier).

The test procedure used was that described above for testing elastic properties. An Instron Model 5564 tensiometer with Merlin Software was used. The test conditions were at 23° C.±2° C. and 50%±5% humidity. Fiber length of test specimens were 50.0 mm. Four specimens were tested and the results are the mean value of the 4 specimens tested. The results are shown in Table I.

TABLE I

| | | | Prior Art | This |
|---|---|---|---|---|
| | | 70 Denier | Melt Spun | Invention |
| | Units | Dry Spun | (40 Denier) | 70 Denier |
| 1^{st} Load Pull @ 100% | g/denier | 0.086 | 0.128 | 0.157 |
| 1^{st} Load Pull @ 150% | g/denier | 0.127 | 0.201 | 0.206 |
| 1^{st} Load Pull @ 200% | g/denier | 0.174 | 0.319 | 0.264 |
| 1^{st} Load Pull @ 300% | g/denier | 0.334 | 0.749 | 0.497 |
| 1^{st} Unload Pull @ 200% | g/denier | 0.028 | 0.035 | 0.020 |
| 1^{st} Unload Pull @ 150% | g/denier | 0.017 | 0.021 | 0.011 |
| 1^{st} Unload Pull @ 100% | g/denier | 0.015 | 0.015 | 0.007 |
| % Set After 1^{st} Pull | g/denier | 39.36% | 17.46% | 63.89% |
| 5^{th} Load Pull @ 100% | g/denier | 0.027 | 0.028 | 0.017 |
| 5^{th} Load Pull @ 150% | g/denier | 0.042 | 0.043 | 0.028 |
| 5^{th} Load Pull @ 200% | g/denier | 0.060 | 0.064 | 0.043 |
| 5^{th} Load Pull @ 300% | g/denier | 0.248 | 0.442 | 0.266 |
| 5^{th} Unload Pull @ 200% | g/denier | 0.028 | 0.036 | 0.020 |
| 5^{th} Unload Pull @ 150% | g/denier | 0.018 | 0.022 | 0.012 |
| 5^{th} Unload Pull @ 100% | g/denier | 0.016 | 0.017 | 0.009 |
| % Set After 5^{th} Pull | g/denier | 47.49% | 26.76% | 71.05% |
| 6^{th} Load Pull Break Load | g/denier | 1.802 | 1.876 | 1.21 |
| 6^{th} Load Pull Break | g/denier | 583.74% | 469.31% | 450.6% |
| Elongation | | | | |

All of the above data are a mean value for 4 specimens tested.

From the above data, it can be seen that the melt spun fibers of this invention have a relative flat modulus curve during the 5^{th} testing cycle. The first cycle is usually disregarded as this is relieving stress in the fiber.

### Example 2

This Example is presented to show the width of a melt spun fiber of this invention as compared to a commercial dry spun fiber. The width was determined by SEM. The results are shown in Table II.

TABLE II

Fiber Width (Microns)

| Denier | Melt Spun (This Invention) | Dry Spun |
|---|---|---|
| 10 | | 34.57 |
| 20 | 48.32 | 69.32 |
| 40 | 73.30 | 117.58 |
| 70 | 89.23 | 228.43 |
| 140 | 127.92 | — |
| 360 | 198.38 | — |

As can be seen, the dry spun fiber has a much higher width and the difference becomes larger as the denier increases.

### Example 3

This Example is presented to show the improved burst strength of the melt spun TPU fiber of this invention as compared to a commercial dry spun polyurethane fiber. 70 denier fibers were used to prepare a single Jersey knit fabric from each type of fiber. The fabric was tested for burst puncture strength according to ASTM D751. The results are shown in Table III. The results are a mean of 5 samples tested.

TABLE III

| Test | Dry Spun | Melt Spun |
|---|---|---|
| Load at Failure (lbs) | 5.78 | 9.03 |
| Displacement at Failure (in.) | 8.7 | 10.6 |
| Load/Thick at Failure (lbf/in.) | 705 | 1250 |
| Energy to Failure (lbf-in) | 23.0 | 40.8 |

It was very surprising that although the melt spun fibers of this invention did not have higher tensile strength than the dry spun fibers, the burst strength of the melt spun fibers were higher.

While in accordance with the patent statutes, the best mode and preferred embodiment has been set forth, the scope of the invention is not limited thereto, but rather by the scope of the attached claims.

What is claimed is:

1. A melt-spun fiber having an ultimate elongation of at least 400% and having a relatively flat modulus in the load and unload cycle between 100% and 200% elongation, wherein the fiber is polyester thermoplastic polyurethane comprising the reaction product of (i) a polyol component, wherein said polyol component consists essentially of a polyester polyol, (ii) a polyisocyanate component; (iii) a chain extender component; wherein the polyester thermoplastic polyurethane is crosslinked with a polyether crosslinking agent.

2. The fiber of claim 1 wherein the modulus of the fiber, on the 5^{th} pull cycle, has a modulus that does not increase by more than 400% on the load cycle between 100% and 200% elongation.

3. The fiber of claim 1 wherein a Jersey knit fabric prepared from said fibers having superior burst puncture strength, wherein superior burst puncture strength means the fibers of said fabric, when said fibers have an average denier of about 70, have a burst puncture strength, as measured by ASTM D751, such that the load/thick at failure is at least 710 lbf/in (124 N/mm).

4. The fiber of claim 1 wherein the fiber is a monofilament fiber that is 30 to 300 microns in diameter.

5. The fiber of claim 1
wherein the denier of the fiber is from 40 to 90;
wherein the modulus of the fiber, on the 5^{th} pull cycle, increases between 80 and 130% on the load cycle between 100% and 200% elongation;
wherein a Jersey knit fabric prepared from said fibers has a burst puncture strength, as measured by ASTM D751, such that the load/thick at failure for the fabric is between 710 and 1600 lbf/in (124 and 280 N/mm); and
wherein the fiber is monofilament and has a diameter of 80 to 100 microns.

6. The fiber of claim 1
wherein the denier of the fiber is from 90 to 160;
wherein the modulus of the fiber, on the 5^{th} pull cycle, increases between 50 and 120% on the load cycle between 100% and 200% elongation; and
wherein the fiber is monofilament and has a diameter of 100 to 150 microns.

7. The fiber of claim 1
wherein the denier of the fiber is from 300 to 400;
wherein the modulus of the fiber, on the 5^{th} pull cycle, increases between 50 and 150% on the load cycle between 100% and 200% elongation; and
wherein the fiber is monofilament and has a diameter of 180 to 220 microns.

8. The fiber of claim 1 wherein a Jersey knit fabric prepared from said fibers have superior burst puncture strength, wherein superior burst puncture strength means the fibers of said fabric, when said fibers have an average denier of about 70, have a burst puncture strength, as measured by ASTM D751, such that the energy to failure is at least 25 lbf-in. (2.8 N-m).

9. The fiber of claim 1 wherein a Jersey knit fabric prepared from said fibers have superior burst puncture strength, wherein superior burst puncture strength means the fibers of said fabric, when said fibers have an average denier of about 70, have a burst puncture strength, as measured by ASTM D751, such that the load at failure is at least 6 pounds (2.7 kg).

10. (canceled)

11. (canceled)

12. The fiber of claim 1 wherein the weight average molecular weight of the fiber is at least 500,000.

13. The fiber of claim 1 wherein the fiber is made from a polymer composition and wherein the weight average molecular weight of said polymer composition is from 500,000 to 1,500,000.

14. A fabric comprising at least two different fibers wherein at least one of said fibers is the fiber of claim 1.

15. A process for producing a melt-spun fiber having an ultimate elongation of at least 400% and having a relatively flat modulus in the load and unload cycle between 100% and 200% elongation an elastic fiber, said process comprising:
(a) melt spinning a thermoplastic elastomer polymer, wherein the thermoplastic elastomer polymer is polyester thermoplastic polyurethane comprising the reaction product of (i) a polyol component, wherein said polyol component consists essentially of a polyester polyol, (ii) a polyisocyanate component; (iii) a chain extender component; wherein the polyester thermoplastic polyurethane is crosslinked with a polyether crosslinking agent. through a spinneret; and
(b) winding the elastic fiber into bobbins at a winding speed which is no greater than 50% of the polymer melt velocity exiting the spinneret.
